(19) United States
(12) Patent Application Publication
(10) Pub. No.: US 2012/0219101 A1
(43) Pub. Date: Aug. 30, 2012

(54) METHOD FOR ASSISTING IN THE OPERATION OF A NUCLEAR REACTOR

(76) Inventors: Annalisa L'Abbate, Paris (FR); Anastasie Lefebvre De Rieux, Paris (FR); Jean-Lucien Mourlevat, Noisy-le-Roi (FR)

(21) Appl. No.: 13/497,385

(22) PCT Filed: Sep. 20, 2010
(86) PCT No.: PCT/EP2010/063810

§ 371 Date: Apr. 26, 2012

(30) Foreign Application Priority Data
Sep. 22, 2009 (FR) 0956498

(51) Int. Cl. G21C 7/36

(52) U.S. Cl. 376/215

(57) ABSTRACT

The present invention relates to a method for assisting in the operation of a nuclear reactor, which comprises the steps of: establishing a request using a man/machine interface (31) interacting with a dedicated operation assistance computer (32) and using a three-dimensional neutron computation code (32a) solving the diffusion equation, referred to as the operation assistance code; unidirectionally transmitting, from a system (10) for monitoring the operation of the reactor core to said operation assistance computer (32), a set of data (13) which are representative of the hardware, geometric, and neutron characteristics of the core, as well as the operating conditions of the core, said data (13) being determined by a three-dimensional neutron code (12) updating the isotope balance of the core during fuel depletion and periodically solving the diffusion equation online, referred to as the monitoring code, said monitoring code (12) being installed on a second separate computer, referred to as the monitoring computer, which is dedicated to said monitoring system (10); determining a change in the behavior of the reactor core using said operation assistance code (32a), said representative) data (13) being used as input data for said operation assistance code (32a).

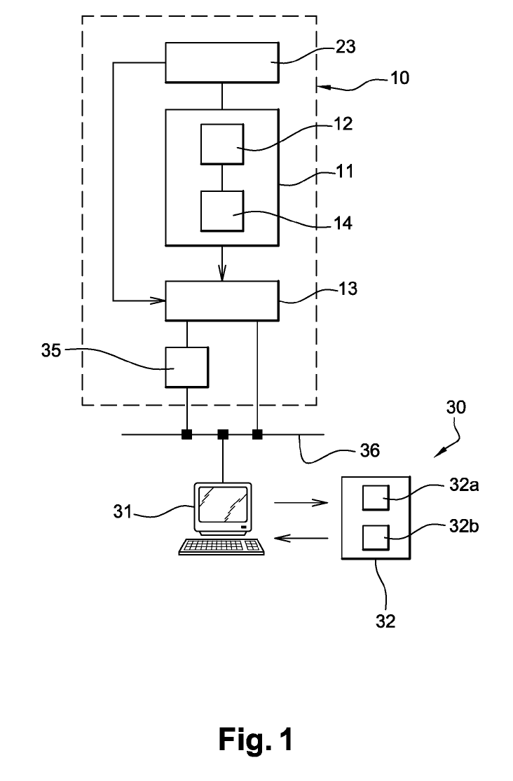

The present invention relates to a method for assisting in the operation of a nuclear reactor coupled with a system for monitoring the operation of the core, and more particularly with a system for the continuous surveillance of the core.

The invention is more particularly suited to pressurised water reactors.

During normal operation, the core of a nuclear reactor must comply with certain conditions which ensure compliance with safety criteria in the event of accident. These conditions (referred to as category 1) correspond to the initial situations adopted in safety studies; if they are exceeded during normal operation, the demonstration of safety is therefore called into question.

Thus, it is necessary to determine whether the production and the volumetric distribution of the neutron flux as well as the volumetric distribution of the power released in the core are in compliance with the conditions corresponding to a normal operation. The continuous verification of compliance with the normal operating limits defines the function of “surveillance of the pre-accident conditions of the core”.

For this purpose, it is necessary to calculate operating parameters of the core of the nuclear reactor, such as the volumetric distribution of the power density in the core, the factors representing the form of the neutron flux (axial offset ΔI, enthalpy increase factor FΔH, etc.) or again the critical heat flux ratio (RFTC) (associated with the critical boiling phenomenon) or the linear power (associated with the fuel fusion phenomenon). These parameters are determined on the basis of measurements representative of the neutron flux or the power released in the core, permitting the distribution of the neutron flux throughout the entire core to be determined in three dimensions.

Various devices for the continuous surveillance of the normal operation of the core are known, said devices determining a volumetric power distribution in the core.

A first system for continuous surveillance of the core is described in patent FR2796196. The latter describes a system for the continuous surveillance of the limits of the normal reactor operation, comprising instrumentation inside the reactor vessel formed by neutron flux detectors comprising collectron measurement probes preferably incorporating a rhodium-based emitter.

Such a surveillance system comprises a surveillance computer, in which a neutron flux computation code permits the instantaneous neutron-flux or power distribution in the core to be obtained taking account of measurements provided by the neutron flux detectors disposed inside the core.

This flux or power distribution then permits operating parameters of the core to be determined, such as:
the linear power (Plin), i.e. the power per unit of length of the fuel elements of the reactor core,
the critical heating ratio (REC) expressing the divergence of the heating of the fuel elements with respect to a critical heating level,
the axial power imbalance of the core (Dpax),
the azimuthal power imbalance of the core (Dpaz),
the negative reactivity margin (MAR).

A second system for continuous surveillance of the core is described in patent application FR2914103. The described system is a continuous surveillance system employing a set of neutron flux measuring detectors disposed on the exterior of the reactor vessel and a set of probes for measuring the temperature of the heat exchange medium at the exit of the fuel assemblies. This surveillance system also comprises a surveillance computer, in which a neutron flux computation code permits the instantaneous neutron-flux or power distribution in the core to be obtained taking account of the measurements provided by the ex-core neutron flux measurement probes and by thermocouples.

In order to obtain a more exact representation of the neutron flux distribution in the core, neutron flux measurements inside the core are additionally carried out at regular, but relatively long intervals, for example of the order of a month, by using for example mobile measurement probes of small dimensions, known as in-core probes, which are generally constituted by fission chambers. The in-core probes are each fixed to the end of a flexible cable, known as teleflex cable, providing for their displacement inside a measurement path of the instrumentation of the core. Thus, the in-core probes periodically provide, by means of a computer forming the computer of the internal system of the core, designated by the abbreviation RIC (in-core reactor or core instrumentation reactor), a precise image of the volumetric power distribution in the core, referred to as a flux map.

The flux map serves as a basis for determining adjustment coefficients for the measurements carried out continuously by the surveillance methods in order that they are representative of the power distribution in the core.

As described in patent FR2796196, outside the periods when the computer of the RIC system is used to prepare neutron flux maps, the neutron code installed in the computer of the RIC system is capable of being used to carry out predictive calculations for the change in operating parameters of the nuclear reactor core and to carry out simulations in order to provide assistance with the control, i.e. in order to define the different possible actions to be taken with the control variables in a given situation.

It may in fact prove useful to be able to predict the change in the neutron flux distribution in the core and thus operating margins, for example of the RFTC type, in order to anticipate control actions permitting the manoeuvrability of the nuclear unit to be optimised.

However, the use of the computer of the RIC system for simulation operations is only possible outside the periods for the acquisition and processing of measurements intended to permit a flux map to be prepared.

Moreover, the preparation of a flux map may also be required following the emergence of various phenomena: for example, in the case of an azimuthal power imbalance alarm generated by the surveillance system or in the case of degraded functioning of the system.

Thus, an operator may find that he is incapable of carrying out a control simulation if the computer of the RIC system is not available.

Moreover, such use of the computer of the RIC system involves giving the operator the possibility of intervening on the computer of the RIC system, this intervention being capable of affecting the proper functioning of the system.

Finally, the use of the computer of the RIC system may involve redefining the neutron flux distribution taking account of measurements representative of the neutron flux inside the core. The implementation of such redefining provides access to a more precise power distribution, but nonetheless adds the need to have available a set of measurements adapted to this functionality.

It will be noted that the configurations described above relate solely to continuous surveillance systems provided with a neutronic calculation code. However, it is also advisable to be able to predict the change in the neutron flux distribution in the core of reactors having monitoring systems that do not play a role in the surveillance of pre-accident conditions. For example, there are reactors provided with a monitoring system providing information to the operator on an informational basis, said monitoring system coexisting with a surveillance system, solely based on the direct use of a measurement. The analogy between a surveillance system and a monitoring system is not therefore systematic.

In this context, the aim of the invention is to overcome the aforementioned problems and relates to providing a method for assisting in the operation of a nuclear reactor permitting an operator to carry out predictive computations or a control simulation of the nuclear reactor at any instant whatever the availability of the computer of the RIC system and not requiring redefining of the neutron flux distribution provided by the computer of the RIC system. In order to do this, the method according to the invention uses an upstream system provided with a neutronic calculation code continuously reproducing the neutron characteristics of the core, whatever the functionalities of the upstream system, which may have only an informative role, and whatever the instrumentation it uses. The method according to the invention therefore applies to any system for the continuous surveillance of normal operating limits provided with a neutronic calculation code, and this whatever the type of instrumentation used for the power distribution measurement in the core by said surveillance system, and more generally applies to any system for monitoring the operation of the core provided with a neutronic calculation code continuously reproducing the neutron characteristics of the core. In other words, the invention also applies to reactors using surveillance systems based exclusively on measurements (i.e. not provided with a neutronic calculation code), since there is a core operation monitoring system available, provided with a neutronic calculation code continuously reproducing the neutron characteristics of the core.

For this purpose, the invention proposes a method for assisting in the operation of a nuclear reactor, characterised in that it comprises steps consisting in:
making a request for assistance in the operation of said reactor by means of a man/machine interface interacting with an operation assistance computer dedicated to said operation assistance and using a three-dimensional neutronic calculation code solving the diffusion equation, referred to as the operation assistance code;
unidirectionally transmitting from a system for monitoring the operation of the reactor core to said operation assistance computer a set of data representative of the composition, geometric and neutronic characteristics of the core, as well as the operating conditions of the core, said data being determined by a three-dimensional neutronic code updating the isotopic balance of the core during fuel burnup and periodically solving the diffusion equation online, referred to as the monitoring code, said monitoring code being installed on a second different computer, referred to as the monitoring computer, which is dedicated to said monitoring system;
determining an evolution in the core behavior of the reactor using said operation assistance code, said data representative of the composition, geometric and neutronic characteristics of the core, as well as the operating conditions of the core and said request for assistance in the operation being used as input data for said operation assistance code.

The term periodically online is understood to mean a periodicity which can range from several seconds (continuous solution of the diffusion equation) to several hours. To advantage, the neutronic calculation code of the method for monitoring the operation solves the diffusion equation continuously, i.e. with a periodicity of the order of a minute, or less than a minute, typically of the order of 30 seconds. Thanks to the invention, it is possible to provide an operator with a tool for assistance in operating the reactor, making it possible for example to predict or to simulate the behaviour of the reactor by making use of data representative of the composition, geometric and neutronic characteristics of the core, as well as actual core operating conditions, these data and conditions being grouped together in the model of the core and computed in particular by a system for monitoring the operation, thus permitting the running and operation of the reactor to be facilitated.

The method according to the invention does not require the use of data adjusted to the measuring means of the instrumentation, or redefining of these data. The method for assisting in the operation according to the invention can therefore be used with an upstream monitoring system, the only condition whereof being that it is provided with a neutronic calculation code.

The coupling between the system for monitoring the operation and the method for assisting in the operation can be made in such a way as to ensure complete absence of any impact on the functioning of the system for monitoring the operation, in particular when the monitoring system is a system for surveillance of pre-accident conditions. The interaction is therefore implemented by a unidirectional transmission of data representative of composition, geometric and neutronic characteristics of the core, as well as core operating conditions, or a core model (the terminology “3D core model” will be used in the following to denote this set of data in the case of a three-dimensional neutron code), determined by the monitoring code of the monitoring system, to the operation assistance computer also comprising a neutronic calculation code.

Thus, a request for assistance in the operation, or any other request from the operator, such as a control simulation, can be implemented independently by the method for assistance in the operation by means of the operation assistance code, without interfering with the operation of the monitoring code and without a possible transmission of data to the monitoring system, the two computation codes being in two different computers (i.e. operating independently of one another). The transfer of information can be made only from the monitoring system to the operation assistance computer; in contrast, the operation assistance computer does not communicate any information to the monitoring system in order that a user error by the operator or a data-processing error does not have repercussions on the core monitoring system.

Contrary to the solution proposed in patent FR2796196, the method according to the invention uses a neutron code for assisting in the operation that is available at any instant, making it possible for example to carry out simulations or predictive computations on the basis of up-to-date core operating conditions and without risking interference with the operation monitoring computer or surveillance computer used for the operation of the reactor, thereby dispensing with the need for redefining the neutron flux distribution with the aid of measurements.

To advantage, the system for the continuous monitoring of the operation of the core is for example a system for continuous surveillance of the operation of the core such as described in patents FR2796196 and FR2914103.

However, as already mentioned above, the scope of the present invention is not limited to the use of a surveillance system. The invention can also be applied to any monitoring system installed upstream of the system for assisting in the operation comprising a neutronic calculation code continuously reproducing the neutron characteristics of the core, whatever the functionalities of the system upstream, which may have a purely informative role, and whatever the instrumentation that it employs.

Thus, the method for assisting in the operation according to the invention is applicable both to a nuclear reactor comprising a surveillance system provided with a neutronic calculation code as well as to a nuclear reactor comprising a surveillance system that does not employ a neutronic calculation code, since the reactor comprises an online core monitoring system (informative for example) provided with a neutronic calculation code.

To advantage, the neutron code of the upstream monitoring system of the present invention is a three-dimensional neutronic calculation code which instantaneously solves the diffusion equation in a periodic manner and updates the isotopic balance of the core during fuel depletion. Thus, the method according to the invention advantageously uses input data formed by a 3D model representing as closely as possible the operating conditions of the core.

The method according to the invention can also have one or more of the following features, considered individually or in all technically possible combinations:
said monitoring code functions continuously, typically with a periodicity of the order of one minute;
said monitoring system is a core surveillance or monitoring system performing a measurement of the neutron flux by means of a set of neutron-flux measurement detectors disposed outside the reactor vessel and a set of probes for measuring the temperature of the coolant fluid at the exit of the fuel assemblies from the core;
said monitoring system is a core surveillance or monitoring system performing a measurement of the neutron flux by means of a set of neutron-flux measurement detectors introduced into the interior of the reactor vessel, in at least a part of the fuel assemblies of said core, said detectors each comprising a plurality of neutron flux measurement probes;
said operation assistance code is identical to the code for monitoring the operation of the core;
said operation assistance code takes into account the operational and control reactivity constraints reactivity to said reactor;
said step of making a request for operation assistance comprises a step in which the operator selects a request among one of the following requests:
   creation of predictive transients,
   evaluation of the capability of the nuclear unit to operate load follow,
   linear extrapolation of the inverse of the count rates of the source level chambers,
   prediction of the evolution of the margins to criticality, in particular in the reactor shut-down phases,
   monitoring of the xenon and/or samarium concentrations after shut-down of the reactor,
   performance of reactivity balance calculations in sub-critical phases and determination of critical parameters,
   calculation of maximum power level attainable in the case of instantaneous return to power,
   optimization of core stabilisation time to perform periodic tests,
   automation of the processing of periodic tests relevant to the core,
   calculation of the isotopic balance and the material balance of the core via predictive fuel burnup calculations;
said request for assistance in the operation said reactor comprises operating parameters, the whose values are defined by the operator, said operating parameters possibly varying as a function of time;
the method comprises a periodic correction step of the core model based on said operation assistance code and/or said monitoring code, said periodic correction step comprising a step to modify intrinsic parameters of the core model;
the method comprises a step to display the results of said step to determine the core behavior evolution on display means of said man/machine interface;
the method comprises a step to recover the set of said data representative of the composition, geometric or neutronic characteristics of the core, as well as the operating the conditions of the core determined by said monitoring code, in the memory and/or storage means;
the method comprises a step for selection by the operator of a set of data representative, at a given instant, of the composition, geometric and neutronic characteristics of the core, as well as the operating conditions of the core, stored in said memory and/or storage means, said memory and/or storage means comprising a plurality of successive sets of data corresponding to given different storage instants;
said step of storing the set of said data representative of the composition, geometrical and neutronic characteristics of the core, as well as the operating conditions of the core determined by said monitoring code, in said memory and/or storage means can be requested at any instant by the operator;
the method comprises a step for recovering on a network the set of data representative of the composition, geometric and neutronic characteristics of the core, as well as the operating conditions of the core determined by said monitoring core, the set of data recovered on the network being capable of being requested by the operator via the man/machine interface and used as input data in said operation assistance code;
the method comprises a step for implementing at least one additional functionality of a non-predictive nature used by said operation assistance computer;
a set of data representative of the composition, geometrical and neutronic characteristics of the core, as well as the operating conditions of the core not determined by said monitoring code, is used as an input to said operation assistance code.

Other features and advantages of the invention will emerge more clearly from the following description thereof, by way of indication and on no account limiting, making reference to the appended figures, among which the single FIGURE is a diagrammatic representation of an architecture comprising means for implementing a method for the continuous monitoring of the operation of the core and means for implementing the method for assisting in the operation according to the invention.

The single FIGURE is a diagrammatic representation of an architecture comprising a core operation monitoring system 10, provided with a neutronic calculation code, coupled with a system 30 for implementing the method for assistance in the operation according to the invention.

Operation assistance system 30 for implementing the method for assisting in the operation according to the invention comprises:
a man/machine interface 31 on which an operator is able to make requests for assistance in operating the reactor, such as for example a simulation request, or a request for predictive computations of the behaviour of the nuclear reactor;
an operation assistance computer 32 incorporating a neutronic calculation code 32a, advantageously a three-dimensional neutronic calculation code, capable of solving the diffusion equation,
mean for recovering a set of data 13 representative of the composition, geometric and neutronic characteristics of the core, and operating conditions of the core, which will be referred to hereinafter as a “3D core model”, from core operation monitoring system 10 located upstream.

3D core model 13 is generated by core operation monitoring system 10 located upstream of system 30.

Monitoring system 10 comprises a monitoring computer 11 provided with a neutron flux computation code 12, advantageously in three dimensions, making it possible to obtain continuously by a computation instantaneous three-dimensional neutron-flux or power distribution 14 in the core, taking account of current values 23 of the operating parameters of the reactor, such as: the mean thermal power of the core, the mean admission temperature of coolant into the vessel, the position operated by the control groups, etc.

Neutronic calculation code 12, based on current values 23 of the operating parameters of the reactor, updates the isotopic balance of the core during depletion of the fuel and solves online, i.e. with a periodicity less than a minute, the diffusion equation in order to restore three-dimensional distribution 14 of the current power of the core, in the form of a set of values of the nuclear power at different points distributed in the core.

It is for example possible to cite, by way of example, neutronic calculation code SMART based on a three-dimensional modelling of the advanced nodal type. The principles of the core neutron computation are described in greater detail in the document “Methods for core neutron computation” (Techniques de L'Ingenieur—B3070—Giovanni B. Bruna and Bernard Guesdon).

Thus, monitoring system 10 continuously generates a 3D model of core 13 corresponding to a set of data representative of the composition, geometric and neutronic characteristics of the core, and operating conditions of the core, in particular grouping together the following data:
the data from the computation of distribution 14 of the current neutron flux or power of the core calculated by neutron code 12 of surveillance computer 11,
current values 23 of the reactor operating parameters required for the use of the neutron flux computation, such as for example:
   the description of the geometry, the isotopy of the materials and elements present in the core,
   the properties of the efficient sections of the materials and in particular of the fuel,
   the data characterising the state of the reactor, such as the produced power level, the temperature of the coolant, the position of the control rods, etc.

The 3D model of core 13, periodically generated by monitoring computer 11, is periodically transmitted to memory or storage means 35, in such a way as to produce a backup of the 3D model of core 13 at different instants. Typically, the 3D model of core 13 is stored in the storage memory once per day.

Storage means 35 are optionally connected to a printer (not represented) permitting certain data of the stored 3D models to be edited upon request by the operator.

Moreover, the 3D model of core 13 can also be transmitted periodically on a network 36 in such a way as to be available at any instant for operation assistance system 30. The 3D model of core 13 is also transmitted on network 36 with each computation step of monitoring code 12, i.e. with a periodicity less than one minute for example.

The operator can also select, via man/machine interface 31, a 3D model of the given core, stored among the plurality of 3D models stored on storage means 35, in order to initiate for example a request for assistance in the operation on the basis of the data of a previous 3D model.

The operator can also request at any instant the storage of a 3D model, thus permitting a backup of the 3D model of the core at an instant determined by the operator, the request being made explicitly to the system via man/machine interface 31 by making an additional storage request (in this case, the operator uses a forced mode). It will be noted that this operation is only possible in the case where the connection between the monitoring computer and the operation assistance computer is not unidirectional.

Moreover, the operator can optionally change, via man/machine interface 31, data of a 3D core model not generated by monitoring computation code 12 of the reactor, as well as data not included in the model (measurements, for example).

The method according to the invention permits the use of different functionalities of operation assistance system 30 upon request from of the operator, by a request being made for assistance with the operation via man/machine interface 31.

Thanks to the invention, the operator can make a request permitting him in particular to anticipate the behaviour of the reactor, or to verify a different operational strategy from the current strategy. Thus, the operator can, as he sees fit, make a request permitting him to implement one of the functionalities used by the method according to the invention, such as for example:
to implement predictive transients making it possible to anticipate the change in the behaviour of the reactor in order that the operator is guided towards the choice of a future control strategy,
to evaluate the capability of the nuclear unit to perform given load-following on the basis of the current state of the core,
to extrapolate linearly the reciprocals of the count rates from the source level chambers,
to predict the change in the negative reactivity, and in particular in the shut-down phases of the reactor,
to monitor the xenon and/or samarium concentrations,
to carry out reactivity balances in sub-critical regime and to determine the critical parameters in order to assist the operator in selecting the re-divergence strategy, taking account of the various control means of the reactivity, and in particular the control of the boron concentration as well as the position of the control rods,
to calculate the maximum power level in the case of an instantaneous return to power as a function of the de-calibration of the control rods and the operating strategy permitting 100% of the nominal power to reached in a minimum time,
to optimise the stabilisation time of the core with a view to carrying out periodic tests, via predictive simulations,
to atomate the evaluation of periodic tests of a neutron nature on the basis of measurements of the flux map system provided by the operator,
to calculate the isotopic balance and the material balance of the core as a function of the progress in the cycle, via predictive depletion calculations.

In addition to neutronic calculation code 32a, operation assistance computer 32 also incorporates other types of data 32b, such as:
the different characteristics and constraints of the control modes known to the person skilled in the art (for example, the control modes commonly referred to as mode A, mode G, mode X or mode T),
the calculations of safety limits to be complied with during operations for normal running of a reactor, as well as other necessary computation codes permitting assistance to be provided in the operation of a nuclear reactor.

When a request for assistance in the operation is made, the operator must define the input data into operation assistance computer 32.

The operator can thus specify:
the 3D model of the core to be used: the operator has the choice between the last stored 3D model, in storage means 35, a stored 3D model stored in storage means 35 and corresponding to an earlier storage instant or again the last 3D model automatically transmitted on network 36,
the list of the parameters that he wishes to define in the course of the evaluation of the behaviour of the reactor during the request.

Thus, computer 32 can receive three types of input data:
parametric input data defined by the operator in order to carry out a function,
input data available via the 3D model of core 13, i.e. typically the description of the neutron characteristics of the core, the position of the control rods, the admission temperature of the coolant, the power level, the concentration of xenon and other isotopes, relating to the time of backup of the 3D core model,
and optionally input data from a complementary acquisition carried out directly by the operation assistance system.

The results of the calculations are then displayed on display means of man/machine interface 31.

The identification of a malfunction of system 30 is indicated to the operator via the use of internal tests of operation assistance system 30 during its operation.

In order properly to understand the functioning of the operation assistance system according to the invention, a particular example of a simulation request made by the operator will be described in detail below.

In the illustrated example, the operator will use the method for assisting in the operation according to the invention in order to simulate a load-following transient on the basis of the current state of the reactor, which is for example at 100% of the nominal power. The load-following transient to be simulated changes according to the following configuration:
a first power level at 100% of nominal power for a period of two hours,
a second power level at 50% of nominal power for a period of eight hours, and
a return to 100% of nominal power,
   the power transitions between the levels having to be carried out as quickly as possible (i.e. at maximum speed).

Via man/machine interface 31, the operator makes a simulation request in order to simulate the behaviour of the reactor faced with a predictive load-following transient, such as described above, by selecting the corresponding predictive functionality.

When the request is made, the operator will specify in input data the transient strategy to be implemented as a function of time as well as “the state” of the core from which he wishes to start the simulation.

In our example, the operator wishes to carry out a simulation on the basis of current data 13 of the 3D core model. In order to do this, the most recent data available of the 3D model are thus recovered on network 36 and transmitted to operation assistance computer 32.

However, if the operator had chosen to carry out the simulation proceeding from a previous state of the core, for example with a 3D core model from the previous day, he would have carried out a search on storage means 35 for a 3D core model of the desired instant and made a local copy in order to transmit the data of the 3D model to operation assistance computer 32.

When the request is made, in the context of the example considered here, the operator also selects the power control parameters via programmed movements of the control rods, and the desired change in the axial power imbalance.

The operator then starts the simulation, the parameters defined by the operator being transmitted to operation assistance computer 32 in such a way that neutronic calculation code 32a can calculate the required change, via a solution, at each time step of the transient, of the diffusion equation.

The results of the calculation are made available to the operator via the display means of man/machine interface 31 for each simulated transient instant. In particular, computer 32 determines:
the change in the boron concentration required to achieve the transient under the desired conditions of changes in the power and the axial power imbalance,
the volumes of water and/or boron that he must inject into the core in order to be able to obtain the desired operating transient,
the predicted operating margins in the case of the adopted transient.

In this way, the operator has a means for judging whether the desired transient can follow a course in compliance with the reactor safety limits. In this precise simulated case, the operator is able to take account of the results of the simulation in order to carry out boration and dilution operations, and thus to anticipate his control strategy.

In the case of a result that does not meet his expectations in the matter of safety, the operator can vary previously defined control parameters of the unit, for example by reducing the transition rate of the power, by restarting a simulation in order to optimise the course taken by its load-following transient, whilst at the same time being assured of the level of the available operating margins throughout the load-following transient.

During the time required to carry out the simulation and the calculations of operation assistance system 30, the operation of upstream monitoring system 10 is at no time disturbed, interrupted, or adversely affected.

One of the advantages of the method according to the invention is the representativeness of the 3D core model being used as input data for the calculations of the operation assistance system, said model in fact incorporating the actual operating conditions of the reactor.

Thus, the data of the 3D model and of the simulation calculations take account of the operating history of the reactor, including short-term effects, such as for example the updated xenon distribution.

Thus, on the basis of a 3D core model, the method for assistance in the operation according to the invention makes it possible, for example, to anticipate the behaviour of the reactor on the basis of a profile of the change in parameters fixed by the operator.

The start of a control simulation, or any other request made by the operator, is carried out independently of the operation of the upstream monitoring system, specific operation assistance computer 32 comprising its own computation codes, thus permitting the functioning of monitoring code 12 not to be disturbed. Moreover, in the case of a unidirectional connection between operation assistance computer 32 and monitoring computer 11, no transmission of data from operation assistance computer 32 to monitoring computer 11 is possible, which permits interactions between the two computers or incorrect interventions on the part of the operator to be prevented.

1. A method for assisting in the operation of a nuclear reactor, comprising the steps:
making a request for assistance in the operation of said reactor by means of a man/machine interface interacting with an operation assistance computer dedicated to said operation assistance and using a three-dimensional neutronic calculation code solving the diffusion equation, referred to as the operation assistance code;
unidirectionally transmitting from a system for monitoring the operation of the reactor core to said operation assistance computer a set of data representative of the composition, geometric and neutronic characteristics of the core, as well as the operating conditions of the core, said data being determined by a three-dimensional neutronic code updating the isotopic balance of the core during fuel burnup and periodically solving the diffusion equation online, referred to as the monitoring code, said monitoring code being installed on a second different computer, referred to as the monitoring computer, which is dedicated to said monitoring system;
determining an evolution in the core behavior of the reactor using said operation assistance code, said data representative of the composition, geometric and neutronic characteristics of the core, as well as the operating conditions of the core and said request for assistance in the operation being used as input data for said operation assistance code.

2. The method for assisting in the operation of a nuclear reactor according to claim 1, wherein said monitoring code functions continuously, typically with a periodicity of the order of one minute.

3. The method for assisting in the operation of a nuclear reactor according to claim 1, wherein the monitoring system is a core surveillance or monitoring system performing a measurement of the neutron flux by means of a set of neutron-flux measurement detectors disposed outside the reactor vessel and a set of probes for measuring the temperature of the coolant fluid at the exit of the fuel assemblies from the core.

4. The method for assisting in the operation of a nuclear reactor according to claim 1, wherein said monitoring system is a core surveillance or monitoring system performing a measurement of the neutron flux by means of a set of neutron-flux measurement detectors introduced into the interior of the reactor vessel, in at least a part of the fuel assemblies of said core, said detectors each comprising a plurality of neutron flux measurement probes.

5. The method for assisting in the operation of a nuclear reactor according to claim 1, wherein said operation assistance code is identical to the code for monitoring the operation of the core.

6. The method for assisting in the operation of a nuclear reactor according to claim 1, wherein said operation assistance code takes into account the operational and control reactivity constraints reactivity to said reactor.

7. The method for assisting in the operation of a nuclear reactor according to claim 1, wherein said step of making a request for operation assistance comprises a step in which the operator selects a request from among the following requests:
creation of predictive transients,
evaluation of the capability of the nuclear unit to operate load follow,
linear extrapolation of the inverse of the count rates of the source level chambers,
prediction of the evolution of the margins to criticality, in particular in the reactor shut-down phases,
monitoring of the xenon and/or samarium concentrations after shut-down of the reactor,
performance of reactivity balance calculations in sub-critical phases and determination of critical parameters,
calculation of maximum power level attainable in the case of instantaneous return to power,
optimization of core stabilisation time to perform periodic tests,
automation of the processing of periodic tests relevant to the core, and
calculation of the isotopic balance and the material balance of the core via predictive fuel burnup calculations.

8. The method for assisting in the operation of a nuclear reactor according to claim 1, wherein said request for assistance in the operation said reactor comprises operating parameters, the whose values are defined by the operator, said operating parameters possibly varying as a function of time.

9. The method for assisting in the operation of a nuclear reactor according to claim 1, further comprising a periodic correction step of the core model based on said operation assistance code and/or said monitoring code, said periodic correction step comprising a step to modify intrinsic parameters of the core model.

10. The method for assisting in the operation of a nuclear reactor according to claim 1, further comprising a step to display the results of said step to determine the core behavior evolution on display means of said man/machine interface.

11. The method for assisting in the operation of a nuclear reactor according to claim 1, further comprising a step to recover the set of said data representative of the composition, geometric or neutronic characteristics of the core, as well as the operating the conditions of the core determined by said monitoring code, in the memory and/or storage means.

12. The method for assisting in the operation of a nuclear reactor according to claim 11, further comprising a step for selection by the operator of a set of data representative, at a given instant, of the composition, geometric and neutronic characteristics of the core, as well as the operating conditions of the core, stored in said memory and/or storage means, said memory and/or storage means comprising a plurality of successive sets of data corresponding to given different storage instants.

13. The method for assisting in the operation of a nuclear reactor according to claim 11, wherein said step of storing the set of said data representative of the composition, geometrical and neutronic characteristics of the core, as well as the operating conditions of the core determined by said monitoring code, in said memory and/or storage means can be requested at any instant by the operator.

14. The method for assisting in the operation of a nuclear reactor according to claim 1, further comprising a step for recovering on a network the set of data representative of the composition, geometric and neutronic characteristics of the core, as well as the operating conditions of the core determined by said monitoring core, the set of data recovered on the network being capable of being requested by the operator via the man/machine interface and used as input data in said operation assistance code.

15. The method for assisting in the operation of a nuclear reactor according to claim 1, further comprising a step for implementing at least one additional functionality of a non-predictive nature used by said operation assistance computer.

16. The method for assisting in the operation of a nuclear reactor according to claim 1, wherein a set of data representative of the composition, geometrical and neutronic characteristics of the core, as well as the operating conditions of the core not determined by said monitoring code, is used as an input to said operation assistance code.
